(19) United States
(12) Patent Application Publication
(10) Pub. No.: US 2006/0155590 A1
(43) Pub. Date: Jul. 13, 2006

(54) Lifestyle protection insurance

(76) Inventor: William Marc Graham, Salisbury, NC (US)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(21) Appl. No.: 11/327,078

(22) Filed: Jan. 6, 2006

Related U.S. Application Data
(60) Provisional application No. 60/642,014, filed on Jan. 7, 2005.

(51) Int. Cl. G06Q 40/00

(52) U.S. Cl. 705/4

(57) ABSTRACT

An insurance product for protecting a wage earner against a reduction in compensation resulting from an event such as involuntary dismissal from employment or military service activation, and subsequent reemployment at a reduced compensation. An insurance product may elect to recover a vesting percentage of paid premiums or to convert a conversion percentage of paid premiums to an equity-building vehicle, such as an annuity, life insurance policy, pension, or an insurance device, such as long term disability insurance or health care insurance. A method for providing and implementing an insurance product to protect a wage earner against a reduction in compensation resulting from such an event is also disclosed.

### CROSS-REFERENCE TO RELATED APPLICATION

This application claims the benefit of, and claims priority to provisional U.S. Patent Application Ser. No. 60/642,014, filed on Jan. 7, 2005, which is incorporated herein by reference in its entirety.

### FIELD OF THE INVENTION

The present invention relates generally to an insurance product or products that protects a wage earner against a reduction in compensation resulting from an event such as involuntary dismissal from employment or military service activation, and subsequent reemployment at a reduced compensation. The present invention also relates to a method or methods for providing and implementing an insurance product to protect a wage earner against a reduction in compensation resulting from such an event.

### BACKGROUND OF THE INVENTION

The employment market in the U.S. has become increasingly fraught with unease in recent years. Numerous external forces have created a situation where many wage earners live in a persistent state of anxiety due to an unsteady job market. Specifically, more and more businesses are looking to improve their financial status by outsourcing or shifting U.S. jobs to overseas markets where wages may be less expensive. Moreover, improvements in technology in foreign markets have expanded the scope of jobs that can feasibly be moved overseas. Now, jobs in both manufacturing and service industries, once thought to be secure, may be shifted to an overseas market with ease. As a result, even wage earners who are able to build a solid relationship with an employer over many years hold concerns regarding their long-term employment stability.

Several consequences arise as a result of this tenuous U.S. employment environment. Persistent concerns regarding a wage earner's ability to support himself or herself with a reliable salary will carry over to the wage earner's dependents and family. Undue stress and discord in the home may lead to difficult family situations such as marital separation and/or divorce. In addition, increased numbers of unemployment claims from wage earners who suffer involuntary dismissal will place an undue burden upon society as a whole.

Particular among these consequences is the fact that many wage earners who struggle to find new employment following an involuntary dismissal accept a replacement employment position with reduced compensation. Many families experience significant difficulty in maintaining a consistent level of compensation in the home following an involuntary dismissal. Accordingly, a need exists for a form of insurance whereby a wage earner who suffers involuntary dismissal for reasons other than, for example, criminal activity, may be protected against a reduction in compensation arising from reemployment at an employment position having a reduced compensation.

Many of these concerns regarding the involuntary dismissal of a wage earner and the maintenance of a consistent level of compensation in the home are paralleled in the context of a member of the National Reserve or armed forces undergoing military service activation or deployment. Accordingly, a need exists for a form of insurance whereby a wage earner who is activated for military service or deployment may be protected against a reduction in compensation upon leaving his or her position of employment for activation.

Another related concern arises when a wage earner must leave active employment or retire at a time prior to attaining eligibility for social security or other retirement benefits. In this situation, a wage earner encounters a gap where he or she is unable to maintain a consistent level of compensation through active employment, but is not yet able to qualify for retirement benefits. Accordingly, a need exists for a form of insurance whereby a wage earner may protect against a reduction in compensation resulting from an involuntary dismissal and reemployment in a position having a reduced compensation and have the option to supplement his or her compensation during the span of time between the termination of active employment and the commencement of retirement benefits.

### SUMMARY OF THE PRESENT INVENTION

Briefly described, the present invention relates to an insurance product for protecting a wage earner against a reduction in compensation resulting from reemployment at a reduced compensation level following an involuntary dismissal from an employment position at a higher compensation level. The term “compensation” may include, but is not limited. to, salary, wages, income, stock options, overtime compensation,. commissions, or bonuses, intangible or otherwise. Whoever implements an insurance product in accordance with the present invention may determine what specific aspects of compensation qualify in determining the total amount of compensation for purposes of the employment position immediately prior to involuntary dismissal as well as the replacement employment position. Additionally, the specific aspects of compensation for determining the total amount of compensation of the employment position immediately prior to involuntary dismissal may vary from the specific amounts of compensation for determining the total amount of compensation of the replacement employment position. Further, the present invention relates to an insurance product that protects against a reduction in compensation resulting from activation for military service. Still further, the present invention relates to an insurance product whereby an insured may elect to have a vesting percentage of paid premiums be returned after a first specified period of time or to have a conversion percentage of premiums be converted into an equity-building vehicle, such as an annuity, life insurance policy, pension, or an insurance device, such as long term disability insurance or health care insurance, after a second specified period of time.

Additionally, the present invention relates to a method or methods for providing such an insurance product to a wage earner. In one method for providing an insurance product, a wage earner may selectively enter into use of an insurance product and commence the payment of premiums as an insured, provided that the wage earner carries an insurable risk of potential reduced compensation arising from an involuntary dismissal and subsequent reemployment, subject to various underwriting criteria. Once various eligibility criteria have been met, an insured may file a claim for benefits resulting from an involuntary dismissal and subsequent reemployment in a position with a reduced level of compensation. Benefits may be paid to an insured for a benefit period as a means of supplementing an insured's reduction in compensation. An insured is thus able to maintain a compensation level that is more consistent with the previous level of compensation and subsequently is better equipped to maintain the lifestyle associated with the employment position immediately prior to involuntary dismissal. Further, benefit payments associated with a filed claim for benefits can hopefully mitigate and minimize discord and stress within the insured's family during replacement employment. Additionally, with the incentive of benefits coinciding with a replacement employment position, the insured is more likely to seek replacement employment without delay. Accordingly, societal costs of the insured's unemployment may be minimized.

In another method for providing such an insurance product, a wage earner who faces the prospect of military activation or deployment for military service may selectively enter into use of an insurance product and commence the payment of premiums. When an insured suffers a loss in compensation as a result of military activation or deployment, an insured may file a claim for lost compensation to supplement the reduced level of compensation, subject to eligibility criteria. An insured is thus able to maintain a level of compensation that is more consistent with the level of compensation prior to military activation or deployment and subsequently is better equipped to maintain the lifestyle associated with the employment prior to military activation or deployment. Moreover, the negative impact of lost compensation upon the activated or deployed insured's family may be mitigated or minimized by the benefits paid to the insured.

In still yet another aspect of such an insurance product, a wage earner may elect to build equity through participation in the insurance product. Upon satisfaction of eligibility criteria, an insured may elect to have a vesting percentage of all paid premiums be returned following passage of a first specified period of time. Additionally, an insured may elect to convert a conversion percentage of all paid premiums following a second specified time to an equity-building vehicle, such as an annuity, life insurance policy, or pension, which vehicle would be payable to the insured or the insured's designee, or an insurance device, such as long term disability insurance or health care insurance, which device would cover personal expenses related to the insured. In accordance with the equity-building vehicle, an insured may treat the insurance product as a form of investment whereby the benefits function as a compensation supplement to maintain long-term financial security for an insured who must leave a position of employment prior to eligibility for other retirement benefits such as social security. Moreover, the annuity or other funds associated with the equity-building vehicle may receive favorable treatment under U.S. tax laws upon payment to the insured or the insured's designee.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is an overall schematic of a method for providing an insurance product in accordance with the present invention whereby a wage earner may selectively be insured against the prospect of a reduced level of compensation for a new position of employment following an involuntary dismissal;

FIG. 2 is an overall schematic of another method for providing an insurance product in accordance with the present invention whereby a wage earner employed, in the civilian sector may selectively be insured against the prospect of military activation or deployment for military service; and

FIG. 3 is an overall schematic of providing an insurance product in accordance with the present invention whereby an insured may elect to have a vesting percentage of premiums paid be returned after a first specified period of time or to have a conversion percentage of premiums be converted into an equity-building vehicle, such as an annuity, life insurance policy, or pension, or an insurance device, such as long term disability insurance or health care insurance, after a second specified period of time.

### DETAILED DESCRIPTION OF THE PREFERRED EMBODIMENTS

An insurance product in accordance with the present invention protects a wage earner against the prospect of a reduction in compensation upon reemployment in a replacement employment position following an involuntary dismissal, or upon reduction in compensation resulting from activation for military service. Further, the insurance product provides an option whereby an insured may elect to have a percentage of paid premiums be returned after a first specified period of time or to have a percentage of premiums converted into an equity-building vehicle, such as an annuity, life insurance policy, or pension, or an insurance device, such as long term disability insurance or health care insurance, after a second specified period of time.

The term “wage earner” as used in the context of the present invention may be a person with either full-time employment or part-time employment. Preferably, the wage earner is a full-time employee with an average of at least thirty-five hours of work time each week. Furthermore, the wage earner may be paid by a salary or hourly wages. Preferably, the full-time wage earner is salaried. The term “insured” as used in the context of the present invention refers to a wage earner who enrolls in the insurance product.

The term “compensation” may include, but is not limited to, salary, wages, income, stock options, overtime compensation, commissions, or bonuses, intangible or otherwise. Whoever implements an insurance product in accordance with the present invention may determine what specific aspects of compensation qualify in determining the total amount of compensation for purposes of the employment position immediately prior to involuntary dismissal as well as the replacement employment position. Additionally, the specific aspects of compensation for determining the total amount of compensation of the employment position immediately prior to involuntary dismissal may vary from the specific amounts of compensation for determining the total amount of compensation of the replacement employment position.

Referring now to the drawings, a method or methods for providing an insurance product in accordance with the present invention are next described. The following description of these method(s) are merely exemplary in nature and are in no way intended to limit the invention, its application, or uses.

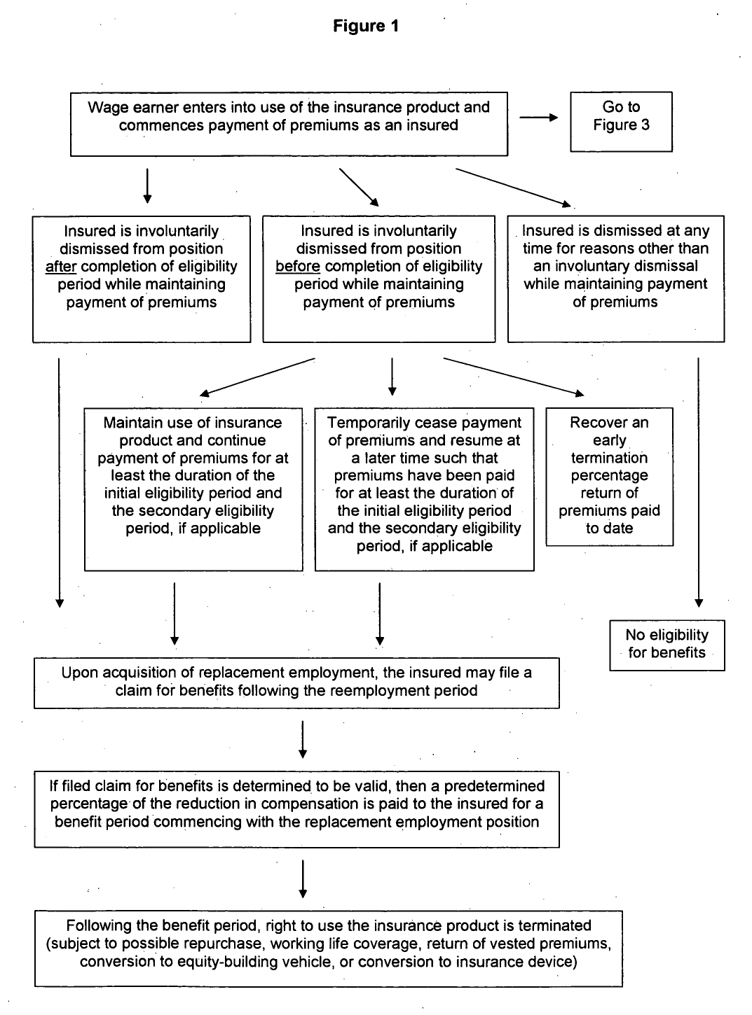

FIG. 1 is an overall schematic of a method for providing an insurance product in accordance with the present invention whereby a wage earner may selectively be insured against the prospect of a reduced level of compensation for a replacement position of employment following an involuntary dismissal. A wage earner who seeks to be insured may, upon the satisfaction of specific eligibility criteria, selectively commence the payment of premiums and become an insured. If an insured is dismissed from his or her employment at any time for a reason other than an involuntary dismissal, the insured is not eligible to file a claim for benefits. Furthermore, in some instances, it is preferred that pursuant to the terms of the insurance product, an insured may not be eligible to file a claim for benefits regardless of the nature of the dismissal. Examples of instances whereby it may be preferred for an insured not to be eligible to file a claim for benefits despite an involuntary dismissal include, but are not limited to: (a) a dismissal and subsequent reemployment at a reduced level of compensation by the same employer, affiliated company of the employer, or subsidiary company of the employer; (b) a dismissal resulting from an insured's misconduct regarding unlawful discrimination; (c) a dismissal resulting from an insured's misconduct regarding sexual harassment; (d) a dismissal resulting from an insured's drug or alcohol abuse; (e) a dismissal resulting from an insured's conviction for a felony related to the employment position; and (f) a dismissal resulting from an insured's actions in a labor dispute such as a strike.

If an insured is involuntarily dismissed from an employment position prior to the completion of an initial eligibility period while continuing payment of premiums, then the insured has several possible options. In accordance with a first option, the insured may opt to recover an early termination percentage of the premiums paid up to the point when premiums cease to be paid. In accordance with a second option, the insured may temporarily cease payment of premiums and resume at a later time. In accordance with a third option, the insured may opt to continue payment of premiums. The second and third options effectively permit an insured to maintain eligibility in a manner such that a claim for benefits may be filed at a future time.

If an insured is involuntarily dismissed from an employment position following the passage of an initial eligibility period and a secondary eligibility period, if applicable, while continuing payment of premiums or the insured maintains eligibility by continuing payment of premiums despite an involuntary dismissal from employment prior to passage of the eligibility period(s) then, if and when the insured is able to obtain a replacement employment position, he or she is eligible to file a claim for benefits if the compensation amount for the replacement employment position is less than that of the employment position immediately prior to involuntary dismissal. If the claim for benefits is determined to be valid, then a predetermined percentage of the reduction in compensation may be paid to the insured for a benefit period that commences with the replacement employment position. In a preferred embodiment of the present invention, the insured's participation in the insurance product is terminated upon commencement of the benefit period.

In accordance with the method for providing an insurance product of FIG. 1, to be eligible for participation as an insured it is preferred that a wage earner be employed in an employment position that is expected to provide regular employment for greater than a six-month period. Thus, temporal or seasonal employment positions or a wage earner who works in accordance with a fixed contract would preferably be excluded from participation. With respect to compensation levels for determining eligibility to participate in an insurance product in accordance with the present invention, a range of acceptable compensation amounts may exist. In a preferred embodiment of the present invention, a minimum annual salary of a wage earner sufficient for eligibility is preferably between about $25,000 and $50,000 and a preferred maximum salary range of a wage earner sufficient for eligibility is between about $150,000 and $200,000. However, a wage earner who earns an annual salary in excess of $200,000 may also be eligible. Such individuals may be subject to enhanced underwriting scrutiny and may be charged an additional premium to acquire coverage. As a matter of course, however, such a wage earner who earns a salary in excess of $200,000 and meets such enhanced underwriting criteria may also receive the advantage of an increase in benefits than what may otherwise be available to an insured. Each of these monetary figures is based upon current dollar values as of the filing of this application.

Additionally, a wage earner earning at or above the maximum salary range is at an increased risk of a reduction in compensation since such a wage earner may experience increased difficulty with respect to finding a replacement employment position at or near the salary level of the employment position immediately prior to involuntary dismissal. Accordingly, such a wage earner may optionally be eligible to use an insurance product in accordance with the present invention provided that additional eligibility criteria have been satisfied, such as the inclusion of a maximum indemnity amount. Acceptable minimum and maximum ranges of salary as well as total compensation for determining wage earner eligibility for participation may fluctuate incrementally, or even by wide margins, in accordance with various economic and non-economic factors.

In accordance with the method for providing an insurance product of FIG. 1, underwriting criteria for determining whether a particular wage earner carries an insurable risk of potential reduced compensation arising from an involuntary dismissal and subsequent reemployment may include, but are not limited to, geographic location, personal employment history, economic factors, and industry-specific criteria. Wage earners associated with certain types of industries such as construction, arts, entertainment, recreation, food services, and accommodations are preferably ineligible due to -unusually high turnover rates associated with these industries. Additionally, wage earners employed by employers with unusually high quantities of involuntary dismissals are preferably ineligible for participation..

In accordance with the method for providing an insurance product of FIG. 1, the initial eligibility period is the period of time that an insured must pay premiums in order to be eligible to file a claim for benefits. The initial eligibility period is preferably a span of time sufficient to operate as a mechanism to reduce or to deter the number of claims filed by an insured who seeks to participate in the insurance product in advance of an anticipated involuntary dismissal. Therefore, the span of time is selected for the initial eligibility period such that profits associated with sale of the insurance product are maximized while providing a reasonable and acceptable product price in the marketplace. In a preferred embodiment of the present invention, the duration of the initial eligibility period is from six months to three years, and more preferably two years. The duration of the initial eligibility period is adjustable and may be arranged to correspond directly with the pricing of the insurance product. For example, an insured willing to pay an increased premium for coverage may have the benefit of a shorter initial eligibility period, and an insured seeking to pay a reduced premium may have a longer initial eligibility period.

In accordance with the method for providing an insurance product of FIG. 1, an insured who uses the insurance product may suffer involuntary dismissal prior to passage of the initial eligibility period. In this instance, the insured may terminate use of the insurance product and request recovery of an early termination percentage of premiums paid up to the point; when payments of premium cease. Additionally, if the insured voluntarily shifts to an employment position that fails to meet other eligibility criteria for participation with the insurance product, participation may be terminated by the insurer and the insured may request recovery of an early termination percentage of premiums paid up to the point when payments of premium cease. In each circumstance, the early termination percentage is selected such that it operates to maximize profits associated with sale of the insurance product while providing a reasonable and acceptable product price in the marketplace. In a preferred embodiment of the present invention, the early termination percentage of paid premiums that may optionally be recovered by the insured is within the range of about fifty percent to one hundred percent, and more preferably sixty percent.

If an insured changes employment during the initial eligibility period, the insured may be subject to the secondary eligibility period during which the insured must be employed for a span of time in the new employment position in order to have eligibility to file a claim for benefits. Preferably, the secondary eligibility period is at least one year. The secondary eligibility period may preferably only apply if the change in employment occurs during the latter portion of the initial eligibility period such that less than a year remains in the initial eligibility period when the change in employment occurs. Notably, however, it is within the scope of the present invention to eliminate a secondary eligibility period following a shift in employment during the initial eligibility period, provided that an insured is subject to an increased premium.

In accordance with the method for providing an insurance product of FIG. 1, an insured who continues payment of premiums during the entirety of the initial eligibility period as well as the secondary eligibility period, if applicable, and who subsequently suffers involuntary dismissal and reemployment at a reduced level of compensation may be eligible to file a claim for benefits. In order to optimize both the marketability and profitability associated with an insurance product in accordance with the present invention, various parameters, such as a benefit period for benefits that may be paid to an insured and a predetermined percentage of the reduction in compensation that may be paid to an insured, may be placed upon the claim for benefits. Market factors affecting the determination of such parameters include the optimization of profits associated with the insurance product and assurance that an acceptable product is placed into the marketplace. As such, the duration of the benefit period, during which the insured may receive benefits in accordance with these factors, is preferably from one to three years, and more preferably two years, from the time that replacement employment commences. Additionally, the predetermined percentage of the reduction in compensation payable to the insured in accordance with these factors is preferably within the range of about fifty percent to one hundred percent, and more preferably sixty percent, of the reduction in compensation. The duration of the benefit period and the predetermined percentage of the reduction in compensation payable to the insured are adjustable and may be arranged to correspond directly with the pricing of the insurance product. For example, an insured willing to pay an increased premium for coverage may have the advantage of a longer benefit period, and an insured seeking to pay a reduced premium may have a shorter benefit period. Similarly, an insured seeking to recover a greater percentage of the reduction in compensation may be subject to an increased premium while an insured willing to recover a reduced percentage of the reduction in compensation may be subject to a reduced premium. In some instances, the predetermined percentage of the reduction in compensation payable to an insured could be as high as one hundred percent, particularly in cases where an insured may require enhanced lifestyle protection for personal tax,.financial, retirement planning, or other reasons.

In accordance with the method for providing an insurance product of FIG. 1, an insurance product may optionally include a reemployment period. The reemployment period is the period of time in which an insured preferably commences a replacement employment position following involuntary termination in order to be eligible to file a claim for benefits. As with the initial eligibility criteria, the replacement employment position preferably meets specific eligibility criteria in order for the insured to be able to file a claim for benefits. Specifically, to be eligible to file a claim for benefits, an insured is preferably reemployed in a full-time replacement employment position with at least an average of thirty-five work hours each week. Additionally, the replacement employment position is preferably a position that is expected to provide regular employment for greater than a six-month period. Thus, temporal or seasonal employment positions or wage earners who work in accordance with a fixed contract would typically be excluded from participation. However, it is also within the scope of the present invention that the replacement employment position may include multiple distinct employment positions in order to satisfy the eligibility criteria to file a claim for benefits. Benefits are to continue for the duration of the benefit period while an insured is actively employed in the replacement employment position. If, however, an insured is dismissed from the replacement employment position, benefits may be terminated unless further replacement employment commences. Further, if an insured dies while benefits are due, benefits may terminate at the insured's death. Otherwise outstanding benefits due to the deceased insured may be paid to the estate of the insured or the insured's designee.

An insured preferably commences a replacement employment position within the duration of the reemployment period in order to have eligibility to file a claim for benefits. It is also within the scope of the present invention that the insured may have eligibility to file a claim for benefits by procuring the replacement employment position within the duration of the reemployment period. Such a period of time promotes the personal interests of an insured by encouraging replacement employment as well as the societal interests in reducing the level of unemployment. The time in which reemployment is to occur is selected such that it operates as an inducement to the insured to acquire a replacement employment position. These considerations are balanced with the desire to maximize the profits associated with sale of an insurance product in accordance with the present invention yet provide a reasonable and acceptable product price in the marketplace. In a preferred embodiment of the present invention, the reemployment period is one year.

In accordance with the method for providing an insurance product of FIG. 1, calculation of the reduction in compensation for purposes of determining the amount payable to an insured who files a valid claim for benefits will preferably entail subtraction of the total compensation amount for the replacement employment position from the total compensation amount of the employment position immediately prior to involuntary dismissal. Calculation of the total compensation for the replacement employment position preferably includes the sum total of all compensation including, but not limited to, salary, wages, income, stock options, overtime compensation, commissions, and bonuses, intangible or otherwise. Calculation of the total compensation for the employment position immediately prior to involuntary dismissal preferably includes salary and/or wages without the addition of other forms of compensation such as stock options, overtime compensation, commissions, and bonuses, intangible or otherwise. While these calculations are advantageous in that they tend to dissuade an insured from fraudulent or improper claims, such calculations may be adjusted to include or exclude the various components of compensation as would be desired. Profits associated with an insurance product of the present invention may be optimized while providing a reasonable and acceptable product price in the market if a maximum salary gap percentage of the total compensation for the employment position immediately prior to involuntary dismissal is determined. Furthermore, the maximum salary gap percentage imposes an incentive upon an insured who has been involuntarily dismissed to accept a replacement employment position with a compensation amount more closely situated to the employment position immediately prior to involuntary dismissal, thus reducing the economic impact of the reduction in compensation. The maximum salary gap percentage is preferably fifty percent of the total compensation amount immediately prior to involuntary dismissal. Thus, in a preferred embodiment of the present invention, the maximum amount of benefits to be received by an insured who files a valid claim for benefits is sixty percent of the reduction in compensation subject to the maximum salary gap percentage of fifty percent of the total compensation amount immediately prior to involuntary dismissal. Additionally, benefits associated with an insurance product in accordance with the present invention are preferably paid on a monthly basis.

In accordance with the method for providing an insurance product of FIG. 1, a wage earner's participation as an insured terminates upon commencement of the benefit period. Thus, in a preferred embodiment, an insured is entitled to a single benefit period during which benefits are paid. However, a wage earner whose participation has terminated after use of the insurance product following a benefit period during which a filed claim for benefits is paid may optionally reapply to commence participation anew subject to various underwriting standards and risk evaluation factors. Included among these underwriting standards and risk evaluation factors may be the type of industry for the replacement employment position, the history of the new employer with respect to involuntary dismissals, the potential of the wage earner to be involuntarily dismissed, the potential of the wage earner to make a fraudulent claim, and the potential of the wage earner to gain compensation at an unrealistically high level in the replacement employment position. Furthermore, it is also within the scope of the present invention that an insured may opt to pay an increased premium for coverage in order to have the option of multiple potential benefit periods during the insured's participation with the insurance product. Thus, such an insurance product would provide coverage during the working life of the insured. Notably, however, an insured seeking the benefit of coverage for his or her working life may be subject to enhanced underwriting scrutiny.

The insurance product of the present invention may be advantageously offered in conjunction with other optional coverages and corresponding benefits that may be marketable to wage earners wishing to be insured against losses incurred from an interruption in employment. Such optional coverages may involve the provision of benefits to an insured during unemployment and may cease once the insured finds replacement employment. For example, an insurance product in accordance with the present invention may be packaged with an additional insurance coverage to provide a separate benefit to cover the COBRA health insurance payments that an insured may incur during the period of unemployment. Additionally, an insurance product in accordance with the present invention may be packaged with an additional insurance coverage to provide a separate benefit for vital personal living expenses such as monthly mortgage, rent and credit card payments. Such optional coverage, if sold in conjunction with an insurance product of the present invention, would require increased premiums for the insured.

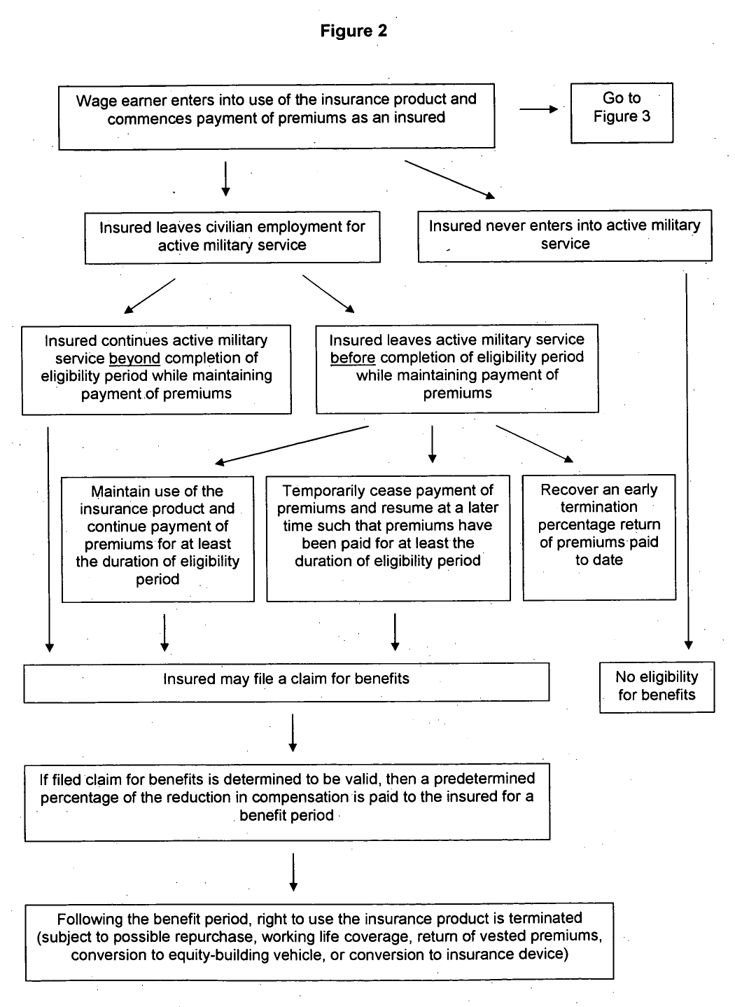

FIG. 2 is an overall schematic of another method for providing an insurance product in accordance with the present invention whereby a wage earner employed in the civilian sector may selectively be insured against the prospect of military activation or deployment for military service. In accordance with the method of the present invention, an insurance product is provided whereby, upon the satisfaction of specific eligibility criteria, a wage earner who faces the prospect of military activation or military service deployment may selectively enter into use of the insurance product and commence payment of premiums, thus becoming an insured. If the insured never ultimately enters into active military service, the insured is not eligible to file a claim for benefits. However, if the insured enters into active military service, then operation of the method of FIG. 2 depends upon whether the insured remains in active military service for an eligibility period. If the insured leaves active military service prior to the completion of the eligibility period while maintaining the payment of premiums, then the insured has several possible options under the policy. In accordance with a first option, the insured may opt to recover an early termination percentage of the premiums paid up to the point when premiums cease to be paid. In accordance with a second option,.the insured may temporarily cease payment of premiums and resume at a later time. In accordance with a third option, the insured may opt to continue use of the insurance product and continue payment of premiums. The second and third options effectively permit an insured to maintain eligibility in a manner such that a claim for lost compensation may be filed at a future time.

On the other hand, If the insured remains in active military service for the eligibility period, and this activation or deployment results in a reduced level of compensation, then the insured may file a claim for benefits to recover a percentage of the reduction in compensation that results from the military service activation or deployment. Benefits may preferably be made in monthly increments for the duration of a benefit period. The insured's participation in the insurance product is terminated upon commencement of the benefit period. Optionally, the insured's spouse or other designated family member may file a claim for benefits once the insured has remained in active military service for the duration of the eligibility period.

A wide range of options is available for use with the foregoing core method. For example, a wage earner who may be a candidate for participation in an insurance product in accordance with the present invention may include a draft-eligible but otherwise non-military civilian, military reservist, or even, in some circumstances, active military personnel. Draft-eligible civilians may wish to mitigate against possible loss in compensation due to sudden selection via military draft. Reservists are more likely to be called to active service, and thus may face correspondingly higher premiums, but are likely to be more interested in preserving a higher compensation level in the not unlikely event that they are called to active service and face a corresponding drop in compensation when they leave their civilian jobs. As will be discussed further below, active military personnel may wish to purchase insurance against the possibility that they are required to remain in active service for a longer period of time than they otherwise anticipated, and thus would potentially suffer from loss in compensation relative to the higher civilian salaries they otherwise might command in that same time period.

Referring to FIG. 2, it is noted that, given the range of possible candidates for participation in an insurance product in accordance with the present invention, the illustrated method may not require the first steps to be carried out in the illustrated sequence. More specifically, it will be apparent that a particular wage earner may enter into use of the product and payment of premiums may commence, either before or after the wage earner enters active military service. Of course, as described previously, some types of wage earners may enter into use of the product but never enter active military service, thereby rendering them ineligible for benefits.

Special options also exist for payment of premiums. More specifically, there is a greater likelihood that the person or entity responsible for payment of the premiums is not the insured. For example, the civilian employer may pay all or part of the premiums as part of a particular employee benefit in order to recruit or retain employees, the government responsible for the military may pay all or part of the premiums in order to encourage enlistment or service, or the like. Moreover, payment may be shared between the insured and the employer, between the insured and the government, or between the employer and the government.

In another option, eligibility for benefits could be affected by the insured's status in the service. For example, dishonorably discharged personnel might lose this particular benefit, or an insured who returns to civilian life prior to the end of the eligibility period through no fault of his or her own may be made eligible anyway, or the government may take over responsibility for payment of premium. Other situations, eligibility criteria, and the like will be apparent to those of ordinary skill in the art.

In yet another option, an insured who returns to civilian life and is otherwise eligible to make a claim, but does not do so, may be permitted to carry his or her policy over to a civilian job without requalifying or without triggering new time period requirements, or are subject only to reduced time period requirements.

Finally, it will be apparent that many or all options available in other insurance products offered in accordance with other embodiments of the present invention may be equally applicable to this military service product.

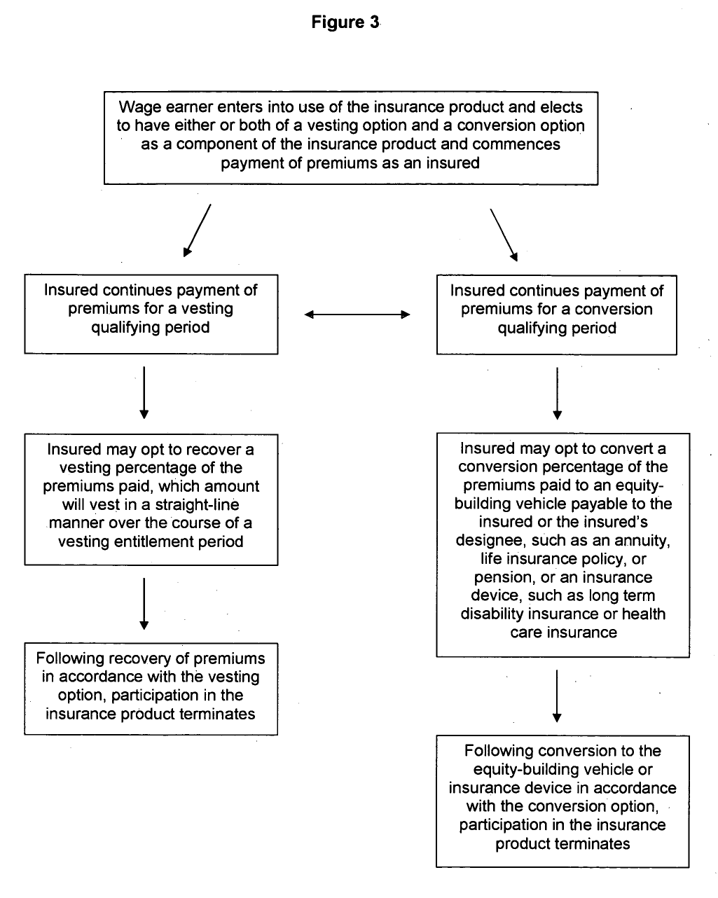

FIG. 3 is an overall schematic of still yet another method for providing an insurance product in accordance with the present invention whereby an insured may elect to have a vesting option whereby a vesting percentage of all premiums paid may be returned after a first specified period of time or to have a conversion option whereby a conversion percentage of premiums may be converted into an equity-building vehicle, such as an annuity, life insurance policy, or pension, or an insurance device, such as long term disability insurance or health care insurance, after a second specified period of time.

In accordance with the method for providing an insurance product of FIG. 3, an insurance product is provided whereby, upon the satisfaction of specific eligibility criteria, the wage earner may selectively enter use of the insurance product and begin the payment of premiums as an insured, which provides the insured with the option to file a claim for lost compensation upon involuntary dismissal and replacement employment at a reduced level of compensation or to build equity. In accordance with the vesting option, once premiums have been paid for a first specified period of time without filing a claim for benefits, which may be termed the vesting qualifying period, the insured may opt to cancel the policy and recover a vesting percentage of the premiums paid. Thus, the vesting percentage of premiums paid to be recovered in accordance with the vesting option will vest upon the completion of the vesting qualifying period. Additionally, in accordance with the conversion option, the insured may opt to continue payment of premiums for a second specified period of time, which may be termed the conversion qualifying period. Upon completion of the conversion qualifying period without filing a claim for benefits, the insured may opt to convert a conversion percentage of the premiums paid to an equity-building vehicle payable to the insured or other designee, such as an annuity, life insurance policy, or pension, or an insurance device, such as long term disability insurance or health care insurance. While it is advantageous to have different specified periods of time corresponding to the vesting qualifying period and the conversion qualifying period so as to provide an incentive to insureds who continue payment of premium, it is also within the scope of the present invention that the vesting qualifying period and the conversion qualifying period may have the same duration, thus permitting both options to become available to an insured upon passage of the same period of time.

In accordance with the method for providing an insurance product of FIG. 3, the vesting qualifying period is preferably a sufficiently lengthy period of time, such as ten years. Notably, the duration of the vesting qualifying period is adjustable and may be arranged to correspond directly with the pricing of the insurance product. For example, an insured willing to pay an increased premium for coverage may have the benefit of a shorter vesting qualifying period, and an insured seeking to pay a reduced premium may have a longer vesting qualifying period. Furthermore, the vesting qualifying period may be tied to the specific financial planning goals of the insured. Moreover, determination of the vesting percentage of the premiums paid that are recoverable by the insured upon the passage of the vesting qualifying period involves many of the same factors applicable to the determination of the predetermined percentage of the reduction in compensation of FIG. 1. Another factor affecting determination or optimization of the applicable vesting percentage is favorable tax treatment for the insured. In accordance with these factors, the vesting percentage of the premiums to be returned to the insured upon policy cancellation is preferably a maximum of sixty percent of the total premiums paid. Further, the amount of premiums that will vest following passage of the vesting qualifying period may vest over the course of a vesting entitlement period, which may preferably be from five to twenty years. In a more preferred embodiment, the vesting entitlement period is ten years and the amount of premiums that may vest during the vesting entitlement period may vest in a straight-line manner from ten years insured to twenty years insured. Thus, six percent of the total premiums paid may vest upon passage of the tenth year of payment of premiums. In such a preferred embodiment, an additional six percent of the total premiums paid may vest upon passage of each additional year up to the twentieth year such that a total of sixty percent of total premiums paid in accordance with the terms of the policy would be available as a return of premium to the insured.

In accordance with the method for providing an insurance product of FIG. 3, the conversion qualifying period is preferably a sufficiently lengthy period of time, such as ten years. Additionally, in accordance with the equity-building vehicle, the age of the insured at which funds associated with an annuity or life insurance policy may be paid to the insured or the insured's designee is preferably sixty-seven. Further, a life insurance policy option associated with the insurance product is preferably a whole life policy. Still further, the insured may selectively designate another individual or the insured's estate as the beneficiary of the funds associated with the annuity or life insurance policy.

Selection of either or both of the vesting option and the conversion option of an insurance product in accordance with the present invention is preferably completed at the time of application for participation. However, it is also within the scope of the present invention than an insured may elect to add either or both of the vesting option and the conversion option at a later time after application. Election of either or both of the vesting option and the conversion option may require payment of an increased premium. In a preferred embodiment, the vesting option and the conversion option are layered such that an insured must first elect the vesting option before being presented with an opportunity to elect the conversion option as well. Notably, an insured who elects either or both of the vesting option and conversion option may also appreciate the aspect of the present invention whereby an insured may elect to pay an increased premium in order to have coverage for his or her working life such that participation with the insurance product does not terminate upon commencement of a single benefit period during which benefits are paid to the insured.

In accordance with the method(s) for providing an insurance product of the present invention, variables associated with eligibility standards, actuarial tables, premium payments, and other relevant parameters would necessarily be dependant upon the individualized business purposes and financial goals of the person or entity that provides the insurance product. Further, one of ordinary skill in the relevant art is capable without undue experimentation of determining desirable actuarial as well as other applicable figures and percentages. Still further, selection of the variables and parameters associated with the method(s) for providing an insurance product may be interdependent such that changes in an individual variable or parameter may necessitate corresponding changes in one or more other variables or parameters in accordance with the business purposes and financial goals of the person or entity that provides the insurance product.

In accordance with the method(s) for providing an insurance product of the present invention, all quantitative estimations are based upon current financial and actuarial data and information available for determination of such estimates. As is readily understood by those of ordinary skill in the relevant art, such estimations may fluctuate by incremental, or even significant, margins and may also vary in accordance with the standards of a specific geographical locale.

In accordance with the method(s) for providing an insurance product of the present invention, a full-time salaried wage earner may preferably pay premiums using a standard payroll deduction or other private transaction.

In accordance with the method(s) for providing an insurance product of the present invention, the insurance product or products of the present invention may preferably constitute a private business transaction not subject to public or government subsidy. Further, the insurance product or products of the present invention may be portable, such that insurance coverage follows the insured, or non-portable, such that insurance coverage remains with the employer. The portable version of an insurance product is preferred. The portable version of the insurance product may preferably be sold through distribution sources direct to the individual wage earner and will follow the insured from employment position to employment position throughout his or her work life. In contrast, the non-portable version of an insurance product may preferably be provided through an employer's benefit program and will terminate upon the wage earner's departure from the employment position. In both portable and non-portable versions of the insurance product, involuntary dismissal may trigger the ability to file a claim when the insured acquires a replacement employment position with a reduced level of compensation.

In accordance with the method(s) for providing an insurance product of the present invention, an insured may renew the insurance product for a new term on an annual basis. At each renewal, premium amounts may be adjusted in accordance with market factors.

An insurance product in accordance with the method(s) of the present invention may be offered, marketed or distributed as a discrete product or in conjunction with related products. Furthermore, such an insurance product in accordance with the present invention may be offered by, marketed by or distributed through financial planners, intermediaries, insurers, agents, and the like individually or as a part of another product such as a product for retirement, disability insurance, health protection, unemployment insurance, COBRA coverage and/or financial planning. Additionally, an insurance product in accordance with the present invention may be offered as a group policy sold and distributed through an employer, which may reduce the amount for premiums to be paid by insureds.

Based upon the foregoing information, it is readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to its preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof. Although specific terms are employed herein, they are used in a generic and descriptive sense only and not for the purpose of limitation.

What is claimed is:

1. An insurance product for lifestyle protection comprising:
an insurance coverage that protects an insured against a reduction in compensation, the reduction in compensation arising from the insured being involuntarily dismissed from an initial employment position having an initial compensation amount and commencing a replacement employment position having a reduced compensation amount that is less than the initial compensation amount.

2. The insurance product in accordance with claim 1 wherein the reduction in compensation is the difference between the initial compensation amount and the reduced compensation amount.

3. An insurance product for lifestyle protection comprising:
an insurance coverage that protects an insured against a reduction in compensation, the reduction in compensation arising from the insured being involuntarily dismissed from an initial employment position having an initial compensation amount and commencing a replacement employment position having a reduced compensation amount that is less than the initial compensation amount, the insurance coverage requiring a premium payment be paid for at least an eligibility period before the insured is eligible to file a claim for benefits.

4. The insurance product in accordance with claim 3 wherein the reduction in compensation is the difference between the initial compensation amount and the reduced compensation amount.

5. The insurance product in accordance with claim 3 wherein the insurance coverage requires a reemployment period during which the insured at least procures the replacement employment position after the involuntary dismissal, to be eligible to file the claim for benefits.

6. The insurance product in accordance with claim 5 wherein upon acceptance of the claim for benefits, the insured receives benefits for a benefit period.

7. The insurance product in accordance with claim 6 wherein the benefits comprise a predetermined percentage of the reduction in compensation.

8. The insurance product in accordance with claim 7 wherein the predetermined percentage is in the range of about fifty percent to one hundred percent.

9. The insurance product in accordance with claim 8 wherein the predetermined percentage is sixty percent.

10. The insurance product in accordance with claim 3 wherein the initial compensation amount is annual earned wages or salary of the insured with or without the inclusion of stock options, overtime compensation, commissions or bonuses.

11. The insurance product in accordance with claim 3 wherein the reduced compensation amount is the annual earned wages or salary of the insured with or Without the inclusion of stock options, overtime compensation, commissions or bonuses.

12. The insurance product in accordance with claim 4 wherein the reduction in compensation is subject to a maximum salary gap percentage of fifty percent of the initial compensation amount.

13. The insurance product in accordance with claim 12 wherein the benefits comprise a predetermined percentage of the reduction in compensation in the range of about fifty percent to one hundred percent.

14. The insurance product in accordance with claim 13 wherein the predetermined percentage is sixty percent.

15. The insurance product in accordance with claim 3 wherein the eligibility period is from six months to three years.

16. The insurance product in accordance with claim 15 wherein the eligibility period is two years.

17. The insurance product in accordance with claim 6 wherein the benefit period is from one to three years.

18. The insurance product in accordance with claim 17 wherein the benefit period is two years.

19. The insurance product in accordance with claim 5 wherein the reemployment period is one year.

20. The insurance product in accordance with claim 6 wherein the insurance coverage terminates upon commencement of the benefit period.

21. The insurance product in accordance with claim 3 wherein the insurance coverage provides protection for the working life of the insured.

22. The insurance product in accordance with claim 6 wherein the insured receives benefits in monthly increments.

23. The insurance product in accordance with claim 3 wherein the insured may optionally have an early termination percentage of the paid premium payments be returned if the insured is involuntarily dismissed during the eligibility period.

24. The insurance product in accordance with claim 23 wherein the early termination percentage is sixty percent.

25. The insurance product in accordance with claim 3 wherein the insurance product further comprises one or more other insurance coverages that protect against expenses incurred during unemployment.

26. The insurance product in accordance with claim 3 wherein the insurance product further comprises an insurance coverage to cover the cost of COBRA health insurance payments during unemployment.

27. The insurance product in accordance with claim 3 wherein the insurance product optionally provides the insured with a vesting option whereby the insured is eligible to recover a vesting percentage of all paid premium payments after passage of a vesting qualifying period.

28. The insurance product in accordance with claim 27 wherein the vesting percentage of all paid premium payments increases in a straight line manner during a vesting entitlement period that commences with expiration of the vesting qualifying period.

29. The insurance product in accordance with claim 28 wherein the vesting percentage has a maximum of sixty percent.

30. The insurance product in accordance with claim 28 wherein the vesting entitlement period is from five to twenty years.

31. The insurance product in accordance with claim 27 wherein the insurance product optionally provides the insured with a conversion option whereby the insured may convert a conversion percentage of all paid premium payments to an equity-building vehicle or an insurance device after passage of a conversion qualifying period.

32. The insurance product in accordance with claim 31 wherein the vesting qualifying period is of a shorter duration than the conversion qualifying period.

33. The insurance product in accordance with claim 31 wherein the vesting qualifying period and the conversion qualifying period are of the same duration.

34. The insurance product in accordance with claim 31 wherein the equity-building vehicle is a life insurance policy.

35. The insurance product in accordance with claim 3 wherein the insurance product optionally provides the insured with a conversion option whereby the insured may convert a conversion percentage of all paid premium payments to an equity-building vehicle or an insurance device after passage of a conversion qualifying period.

36. The insurance product in accordance with claim 35 wherein the equity-building vehicle is a life insurance policy.

37. An insurance product for lifestyle protection comprising:
an insurance coverage that protects an insured against a reduction in compensation, the reduction in compensation arising from the insured leaving an initial employment position having an initial compensation amount and being activated or deployed for military service, the military service having a reduced compensation amount that is less than the initial compensation amount.

38. The insurance product in accordance with claim 37 wherein the reduction in compensation is the difference between the initial compensation amount and the reduced compensation amount.

39. An insurance product for lifestyle protection comprising:
an insurance coverage that protects an insured against a reduction in compensation, the reduction in compensation arising from the insured leaving an initial employment position having an initial compensation amount and being activated or deployed for military service, the military service having a reduced compensation amount that is less than the initial compensation amount, the insurance coverage requiring a premium payment be paid before the insured is eligible to file a claim for benefits.

40. The insurance product in accordance with claim 39 wherein the reduction in compensation is the difference between the initial compensation amount and the reduced compensation amount.

41. The insurance product in accordance with claim 39 wherein the insured remains in active military service for at least an eligibility period to be eligible to file the claim for benefits.

42. The insurance product in accordance with claim 41 wherein, upon acceptance of the claim for benefits, the insured receives benefits for a benefit period.

43. The insurance product in accordance with claim 42 wherein the benefits comprise a predetermined percentage of the reduction in compensation.

44. The insurance product in accordance with claim 42 wherein the insurance coverage terminates upon commencement of the benefit period.

45. The insurance product in accordance with claim 42 wherein the insured receives benefits in monthly increments.

46. The insurance product in accordance with claim 41 wherein the insured may optionally have an early termination percentage of the paid premium payments be returned if the insured leaves active military service during the eligibility period.

47. The insurance product in accordance with claim 39 wherein the insurance product optionally provides the insured with a vesting option whereby the insured is eligible to recover a vesting percentage of all paid premium payments after passage of a vesting qualifying period.

48. The insurance product in accordance with claim 47 wherein the insurance product optionally provides the insured with a conversion option whereby the insured may convert a conversion percentage of all paid premium payments to an equity-building vehicle or an insurance device after passage of a conversion qualifying period.

49. The insurance product in accordance with claim 39 wherein the insurance product optionally provides the insured with a conversion option whereby the insured may convert a conversion percentage of all paid premium payments to an equity-building vehicle or an insurance device after passage of a conversion qualifying period.

50. A method for providing an insurance product for lifestyle protection, the method comprising:
offering insurance coverage to protect an -insured against a reduction in compensation arising from the insured being involuntarily dismissed from an initial employment position having an initial compensation amount and commencing a replacement employment position having a reduced compensation amount that is less than the initial compensation amount.

51. The method in accordance with claim 50 wherein the reduction in compensation is the difference between the initial compensation amount and the reduced compensation amount.

52. A method for providing an insurance product for lifestyle protection, the method comprising:
(a) offering insurance coverage to protect an insured against a reduction in compensation arising from the insured being involuntarily dismissed from an initial employment position having an initial compensation amount and commencing a replacement employment position having a reduced compensation amount that is less than the initial compensation amount and
(b) requiring a premium payment be paid for at least an eligibility period before the insured is eligible to file a claim for benefits.

53. The method in accordance with claim 52 wherein the reduction in compensation is the difference between the initial compensation amount and the reduced compensation amount.

54. The method in accordance with claim 52 further comprising requiring the insured to at least procure the replacement employment position within a reemployment period after the involuntary dismissal to be eligible to file the claim for benefits.

55. The method in accordance with claim 54 further comprising accepting the claim for benefits and providing the insured with benefits for a benefit period.

56. The method in accordance with claim 55 wherein the benefits comprise a predetermined percentage of the reduction in compensation.

57. The method in accordance with claim 52 wherein the method further comprises providing the insured with a vesting option whereby the insured is eligible to recover a vesting percentage of all paid premium payments after passage of a vesting qualifying period.

58. The method in accordance with claim 52 wherein the method further comprises providing the insured with a conversion option whereby the insured may convert a conversion percentage of all paid premium payments to an equity-building vehicle or an insurance device after passage of a conversion qualifying period.

59. The method in accordance with claim 52 wherein the method further comprises providing one or more other insurance coverages that protect against expenses incurred during unemployment.

60. A method for providing an insurance product for lifestyle protection comprising, the method comprising:
offering an insurance coverage to protect an insured against a reduction in compensation arising from the insured leaving an initial employment position having an initial compensation amount and being activated or deployed for military service, the military service having a reduced compensation amount that is less than the initial compensation amount.

61. The method in accordance with claim 60 wherein the reduction in compensation is the difference between the initial compensation amount and the reduced compensation amount.

62. A method for providing an insurance product for lifestyle protection comprising, the method comprising:
(a) offering an insurance coverage to protect an insured against a reduction in compensation arising from the insured leaving an initial employment position having an initial compensation amount and being activated or deployed for military service, the military service having a reduced compensation amount that is less than the initial compensation amount and
(b) requiring a premium payment be paid before the insured is eligible to file a claim for benefits.

63. The method in accordance with claim 62 wherein the reduction in compensation is the difference between the initial compensation amount and the reduced compensation amount.

64. The method in accordance with claim 62 further comprising requiring the insured to remain in active military service for at least an eligibility period to be eligible to file the claim for benefits.

65. The method in accordance with claim 64 further comprising accepting the claim for benefits and providing the insured with benefits for a benefit period.

66. The method in accordance with claim 65 wherein the benefits comprise a predetermined percentage of the reduction in compensation.

67. The method in accordance with claim 62 wherein the method further comprises providing the insured with a vesting option whereby the insured is eligible to recover a vesting percentage of all paid premium payments after passage of a vesting qualifying period.

68. The method in accordance with claim 62 wherein the method further comprises providing the insured with a conversion option whereby the insured may convert a conversion percentage of all paid premium payments to an equity-building vehicle or an insurance device after passage of a conversion qualifying period.

69. A method of implementing an insurance product to protect an insured against a reduction in compensation arising from the insured being involuntarily dismissed from an initial employment position having an initial compensation amount and commencing a replacement employment position having a reduced compensation amount that is less than the initial compensation amount, the method comprising:
(a) enrolling the insured in the insurance product and
(b) receiving premium payments from the insured for at least an eligibility period.

70. A method of implementing an insurance product to protect an insured against a reduction in compensation arising from the insured being involuntarily dismissed from an initial employment position having an initial compensation amount and commencing a replacement employment position having a reduced compensation amount that is less than the initial compensation amount, the method comprising:
(a) processing a claim for benefits and
(b) providing benefits to the insured for a benefit period.

71. The method in accordance with claim 70 further comprising requiring the insured to at least procure the replacement employment position within a reemployment period following the involuntary dismissal to be eligible to file the claim for benefits.

72. A method of implementing an insurance product to protect an insured against a reduction in compensation arising from the insured leaving an initial employment position having an initial compensation amount and being activated or deployed for military service, the military service having a reduced compensation amount that is less than the initial compensation amount, the method comprising:
(a) enrolling the insured in the insurance product and
(b) receiving a premium payment from the insured.

73. A method of implementing an insurance product to protect an insured against a reduction in compensation arising from the insured leaving an initial employment position having an initial compensation amount and being activated or deployed for military service, the military service having a reduced compensation amount that is less than the initial compensation amount, the method comprising:
(a) requiring the insured to remain in active military service for at least an eligibility period to be eligible to file a claim for benefits;
(b) processing the claim for benefits and
(c) providing benefits to the insured for a benefit period.
